(19) United States
(12) Patent Application Publication
(10) Pub. No.: US 2004/0061783 A1
(43) Pub. Date: Apr. 1, 2004

(54) Digital camera displaying communication state and control method thereof

(75) Inventors: Moon-Jung Choi, Seongnam-si (KR); Hyuk-Soo Son, Seongnam-si (KR)

Correspondence Address: GARDNER CARTON & DOUGLAS LLP, 191 N. WACKER DRIVE, SUITE 3700, CHICAGO, IL, 60606, US

(73) Assignee: Samsung Techwin Co., Ltd., Changwon-city (KR)

(21) Appl. No.: 10/672,095

(22) Filed: Sep. 26, 2003

(30) Foreign Application Priority Data
Sep. 26, 2002 (KR) 2002-58458

(51) Int. Cl. H04N 5/225

(52) U.S. Cl. 348/207.1

(57) ABSTRACT

Provided is a digital camera having a recording medium and a communication interface. The digital camera transmits data files on the recording medium to a second device, such as a computer, through the communication interface, or receives data files stored on a computer through the communication interface for storage of the received data files on the recording medium. On a display panel, the digital camera displays an initialization state of the communication interface, a transceiving (transmitting or receiving) state of the data files, and an electrical connection state between the camera and the computer.

### BACKGROUND OF THE INVENTION

This application claims the priority of Korean Patent Application No. 200258458 filed on Sep. 26, 2002 in the Korean Intellectual Property Office, the disclosure of which is incorporated herein in its entirety by reference.

1. Field of the Invention

The present invention relates to a digital camera and a control method thereof. More particularly, the present invention relates to a digital camera having a recording medium and a communication interface. Through the communication interface, such a camera may either transmit data files on the recording medium to another device such as a computer, or receive data files from another device (such as a computer) for storage on the recording medium.

2. Description of the Related Art

When a digital camera connects to a computer through a communication interface (such as a USB interface), a typical digital camera (for example, digital camera models DSC-P9 and DSC-P1 manufactured by SONY Corporation) displays a message indicating connection with the computer. Referring to FIG. 1A, digital camera model “DSC-P9” of SONY Corporation, displays the message “USB MODE NORMAL” in order to indicate connection to the computer. Likewise, referring-to FIG. 1-B, digital camera model “DSC-P1” of the same company displays the message “PC MODE USB” when indicating connection to the computer.

Thus, when a user transmits data files of a digital camera's recording medium from the camera to a computer or transmits the data files stored on a computer from the computer to the camera for storage on the recording medium of the camera, it is difficult for the user to monitor the precise state of communication between the camera and computer.

### SUMMARY OF THE INVENTION

To solve the above and other problems, the present invention provides a digital camera and a control method that provides greater convenience to a user by enabling the user to monitor the state of communication between the camera and another device such as a computer. Examples of such communication include when a user transmits data files on a digital camera's recording medium to a computer through a communication interface, and when a user transmits the data files stored on a computer to a camera through the camera's communication interface for storage of the files on the camera's recording medium.

According to an aspect of the present invention, a digital camera has a recording medium and a communication interface. The recording medium may be insertable through an interface such as a memory card slot, or may be relatively fixed within the camera. The communication interface may be any electronic data interface such as a USB interface, an infrared interface, or a WiFi interface. The digital camera transmits data files on the recording medium to a second device such as a computer through the communication interface, or receives data files stored on a computer through the communication interface for storage of the received data files on the recording medium. On a display panel, the digital camera displays an initialization state of the communication interface, a transceiving (transmitting or receiving) state of the data files, and an electrical connection state between the camera and the computer.

According to another aspect of the present invention, a method of controlling a digital camera having a recording medium and a communication interface, and capable of transmitting data files on the recording medium to a second device such as a computer through the communication interface, or receiving data files stored on a computer through the communication interface for storage of the received data files on the recording medium. The method includes: displaying an initialization state while initializing the communication interface (an initialization display step), if the computer and the communication interface are connected to each other; displaying a transceiving state of the data files, if the data files stored in the digital camera are transmitted to the computer through the communication interface; displaying a transceiving state of the data files (a file transceiving display step) when the data files stored in the computer are transmitted to the digital camera through the communication interface; and displaying an unloading state (an unloading display step) if the digital camera is unloaded from the computer.

### BRIEF DESCRIPTION OF THE DRAWINGS

The above and other features and advantages of the present invention will become more apparent by describing in detail preferred embodiments thereof with reference to the attached drawings in which:

FIGS. 1A and 1B are views illustrating screens of display panels of typical digital cameras when they are connected to a computer;

FIG. 2 is a block diagram illustrating the configuration of a digital camera according to a preferred embodiment of the present invention;

FIG. 3 is a block diagram illustrating the configuration and function of a USB interface of the digital camera of FIG. 2;

FIG. 4 is a flowchart explaining a communication state display algorithm of a digital signal processor of the digital camera of FIG. 2;

FIG. 5 is a flowchart explaining an initialization display routine of the algorithm of FIG. 4;

FIG. 6A is a view illustrating a color LCD screen when Step 703 of FIG. 5 is performed;

FIG. 6B is a view illustrating a color LCD screen when Step 706 of FIG. 5 is performed;

FIG. 7 is a flowchart explaining a file transceiving display routine of the algorithm of FIG. 4;

FIG. 8A is a view illustrating a color LCD screen when Step 714 of FIG. 7 is performed;

FIGS. 8B and 8C are views illustrating color LCD screens when Step 716 of FIG. 7 is performed;

FIG. 9 is a flow chart for explaining an unloading display routine of the algorithm of FIG. 4; and

FIG. 10 is a view illustrating a color LCD screen when Step 722 of FIG. 9 is performed.

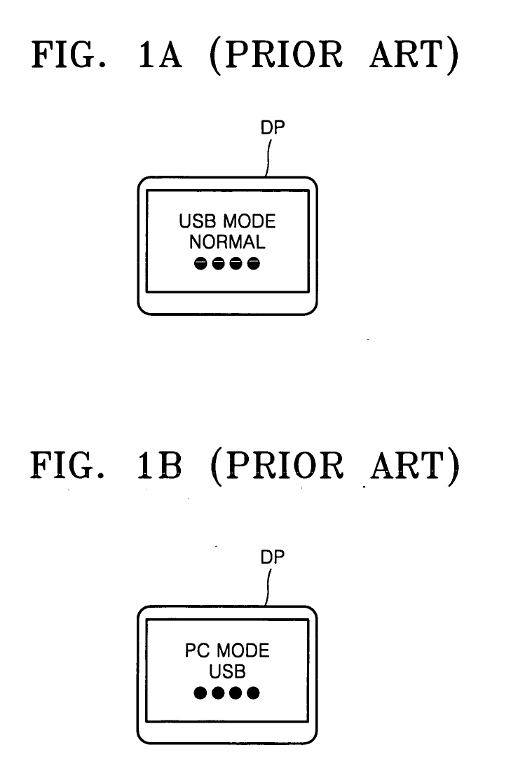

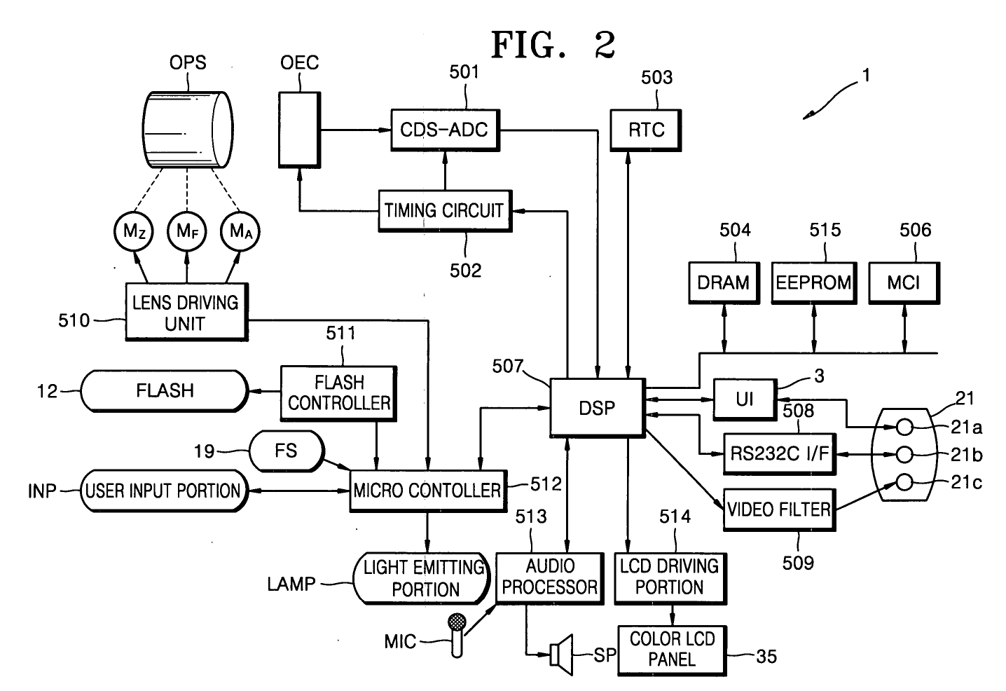

### DETAILED DESCRIPTION OF THE INVENTION

Referring to FIG. 2, the configuration and operation of a digital camera according to the present invention are described below. In a digital camera 1 according to the present invention, an optical system OPS, including a lens portion and a filter portion, optically processes light from an object. When a user presses a wide-angle zoom button or a telephoto zoom button included in a user input portion INP, a corresponding signal is input to a microcontroller 512. Accordingly, as the microcontroller 512 controls a lens-driving unit 510, a zoom motor M_{Z} is driven to move a zoom lens in the optical system OPS. The position of a focus lens in the optical system OPS is adjusted according to the position of the zoom lens.

In an automatic focus mode, as the microcontroller 512 controls the lens-driving portion 510, a focus motor M_{F} is driven. Accordingly, the focus lens in the optical system OPS is moved to any point between a frontmost position and a rearmost position. In doing so, the position of the focus lens is set where a high-frequency component of an image signal has the largest value. The position of the focus lens may be the driving step number of the focus motor M_{F},

Reference numeral M_{A} denotes a motor for driving an aperture in the optical system OPS.

An optoelectric converter OEC, which is a charge coupled device (CCD) or a complementary metal-oxide-semiconductor (CMOS), converts light from the optical system OPS to an electric analog signal. A digital signal processor (DSP) 507 controls a timing circuit 502 to control the operation of the optoelectric converter OEC and an analog-to-digital (A/D) converting portion. A correlation double sampler and analog-to-digital convert (CDS-ADC) device 501, which is the A/D converting portion, processes an analog signal from the optoelectric converter OEC by removing high-frequency noise and adjusting the signal's amplitude, and converts the analog signal to a digital signal. The DSP 507, operated by the control of the microcontroller 512, processes a digital signal from the CDS-ADC device 501 to generate a digital image signal that contains brightness and chrominance signals.

A light-emitting portion LAMP, driven by the microcontroller 512, includes a self-timer lamp, an auto-focus lamp, and a flash-ready lamp. The self-timer lamp operates in a self-timer mode at a time related to a set time between the pressing of a shutter button and the operation of a shutter. The auto-focus lamp operates when an object is well focused. The flash-ready lamp operates when a flash 12 is in a ready state.

A user input portion INP includes the shutter button, a mode dial, a function-selection button, a monitor button, a confirm/delete button, an enter/play button, a menu button, the wide-angle zoom button, the telephoto zoom button, an up movement button, a right movement button, a down movement button, and a left movement button. The mode dial is used to set certain particular operation modes, for example, a still image mode, a night view mode, a motion picture mode, a reproduction mode, a computer connection mode, and a system setting mode. The function-selection button is used to select any of the operation modes of a digital camera—for example, the still image mode, the night view mode, the motion picture mode, and the reproduction mode. The monitor button is used to control the operation of a color LCD panel 35. For example, when a user first presses the monitor button, an image of an object and photography information thereof are displayed on the color LCD panel 35. When the monitor button is pressed a second time, only the image of the object is displayed on the color LCD panel 35. Pressing the monitor button a third time will shut off electric power to the color LCD panel 35. The confirm/delete button is used to confirm or delete when the user sets each mode. The enter/play button is used to input a user's data or perform a stop or play function in the reproduction mode. The menu button is used to display a menu for a selected operation mode. The functions of the wide-angle zoom button and the telephoto-zoom button are described above. The up movement button, the right movement button, the down movement button, and the left movement button are used for a variety of purposes according to each mode.

The digital image signal from the DSP 507 is input to an LCD driving portion 514, and thus an image is displayed on the color LCD panel 35.

An audio processor 513 outputs a voice signal from a microphone (MIC) to the DSP 507 or a speaker SP, and outputs an audio signal from the DSP 507 to the speaker SP.

The microcontroller 512 controls the operation of the flash controller 511 according to a signal from a flash light sensor (FS) 19 to drive the flash 12.

A dynamic random access memory (DRAM) 504 temporarily stores a digital image signal from the DSP 507. An electrically erasable programmable read only memory (EEPROM) 515 stores an algorithm and setting data needed for the operation of the DSP 507. A memory card (not shown) is inserted in or ejected from a memory card interface (MCI) 506.

An external connection portion 21 includes a universal serial bus (USB) connection portion 21a, an RS232C connection portion 21b, and a video output portion 21c. The digital image signal from the DSP 507 can be transmitted in a serial communication through a USB interface (UI) 3 and the USB connection portion 21a, through an RS232C interface 508 and the RS232C connection portion 21b, or as a video signal through a video filter 509 and the video output portion 21c.

The DSP 507 transmits data files of the memory card connected to the MCI 506 to the computer through the UI 3 or receives the data files stored in the computer through the UI 3 and stores the received data files in the memory card. The DSP 507 displays the initialization state of the UI 3, the transceiving state of the data files, and the electrical connection state with the computer, on the color LCD panel 35.

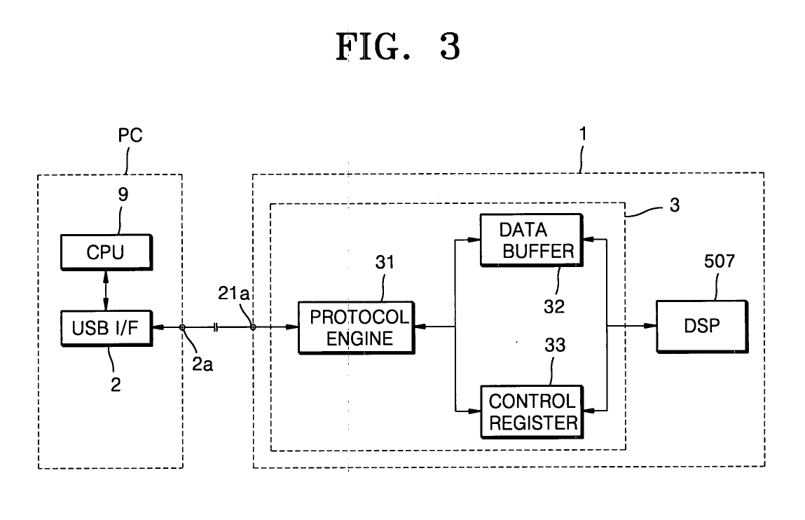

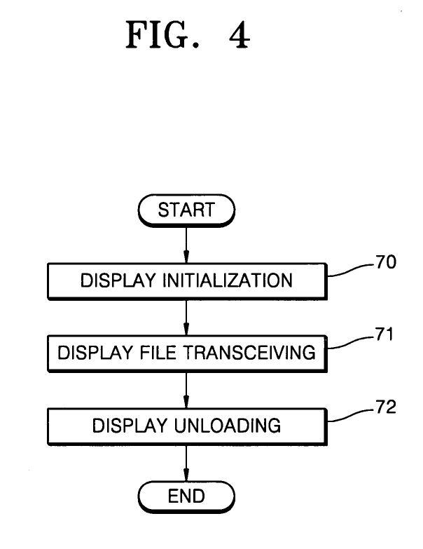

FIG. 3 shows the configuration and function of the UI 3 of the digital camera 1 of FIG. 2. FIG. 4 shows the communication state display algorithm of the DSP 507 of the digital camera 1 of FIG. 2. The display of a communication state in the digital camera 1 according to the present invention is described below with reference to FIGS. 2 through 4.

The UI 3 of the digital camera 1 according to the present invention includes a protocol engine 31, a data buffer 32, and a control register 33. The protocol engine 31 classifies data input through a central processing unit (CPU) 1 of the digital camera 1 through a USB interface (USB I/F) 2, a USB connection portion 2a, and a USB connection portion 21a of the digital camera 1. The protocol engine 31 inputs data files to a data buffer 32 and communication state data to a control register 33. The protocol engine 31 also merges data files from the data buffer 32 and communication state data from the control register 33 by means of a USB protocol, and transmits the merged data to a personal computer (PC). The data buffer 32 temporarily stores the data files from the protocol engine 31 and inputs the temporarily stored data to the DSP 507. The data buffer 32 also temporarily stores data files from the DSP 507 and inputs the temporarily stored data to the protocol engine 31. The control register 33 temporarily stores the communication state data from the protocol engine 31 and inputs the temporarily stored data to the DSP 507 and also temporarily stores communication state data from the DSP 507 and inputs the temporarily stored data to the protocol engine 31.

The UI 3 is initialized by the DSP 507. Data regarding the initialization state of the UI 3 is input to the LCD driving portion 514 from the DSP 507 and displayed on the color LCD panel 35 (Step 70). After the initialization, the camera engages in communication with the PC, and the DSP 507 displays the transceiving state of the data files on the color LCD panel 35 according to the communication state data input through the control register 33 from the protocol engine 31 (Step 71). When an electrical connection between the PC and the digital camera 1 is disengaged by user manipulation of the PC, the camera 1 is in an unloading state, and the DSP 507 displays information indicating the current state on the color LCD panel 35 (Step 72).

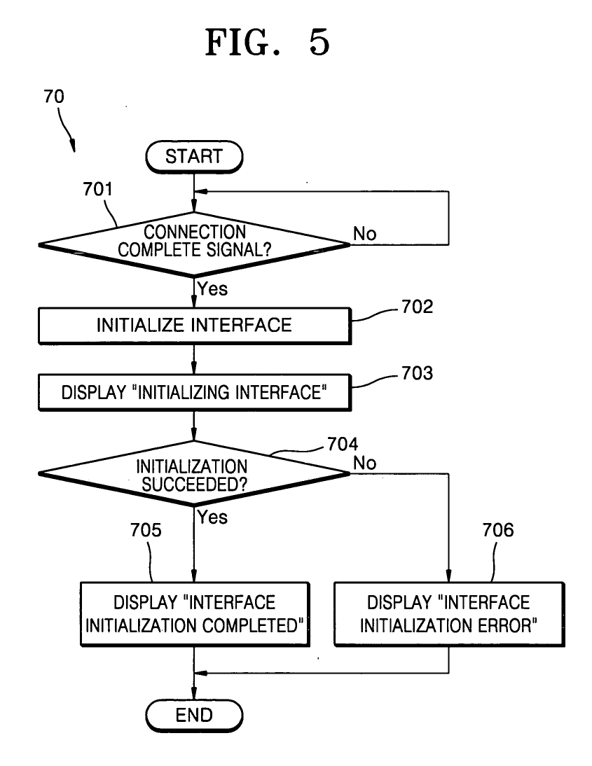

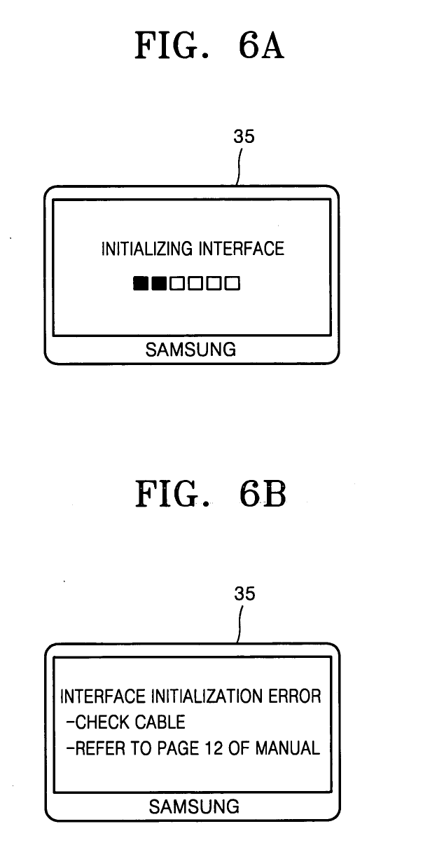

FIG. 5 shows the initialization display routine (Step 70) for the algorithm of FIG. 4. FIG. 6A shows a screen of the color LCD panel 35 of FIG. 2 when Step 703 of FIG. 5 is performed. FIG. 6B shows a screen of the color LCD panel 35 when Step 706 of FIG. 5 is performed. The initialization display routine (Step 70) of the algorithm of FIG. 4 is described below with reference to FIGS. 3, 5, 6A, and 6B.

When a user connects the USB connection portion 2a of the PC and the USB connection portion 21a of the digital camera 1 by using a USB connector, a connection complete signal is input to the DSP 507 through the control register 33 from the protocol engine 31 (Step 701). Accordingly, the DSP 507 initializes the UI 3 (Step 702) and displays the message “Initializing Interface” as well as state indication bars (Step 703, please also refer to FIG. 6A). Next, if the initialization of the UI 3 succeeds, the message “Interface Initialization Completed” is displayed (Step 705). If the initialization fails, the message “Interface Initialization Error” and a message offering guidance to remedy the error are displayed (Step 706, please also refer to FIG. 6B).

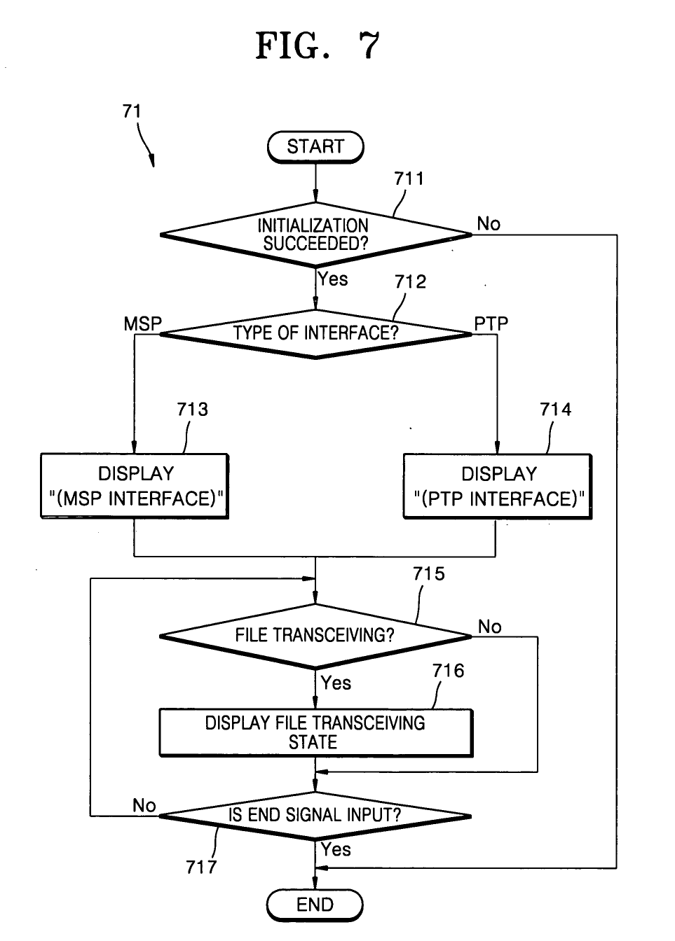

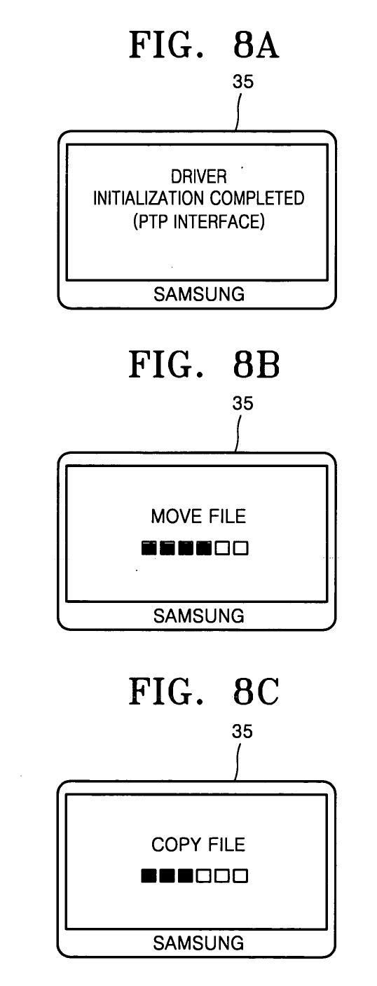

FIG. 7 shows a file transceiving display routine (Step 71) for the algorithm of FIG. 4. FIG. 8A shows a screen of the color LCD panel 35 of FIG. 2 when Step 714 of FIG. 7 is performed. FIGS. 8B and 8C show screen displays of the color LCD panel 35 when Step 716 of FIG. 7 is performed. The file transceiving display routine (Step 71) of the algorithm of FIG. 4 is described below with reference to FIGS. 3 and 7 through 8C.

First, when the initialization of the UI 3 does not succeed in the initialization display routine (Step 70), the file transceiving display routine (Step 71) is terminated (Step 711). Otherwise, when the initialization does succeed, the routine continues on with the steps below (Step 711).

If the initialization succeeds, the type of the UI 3 is confirmed (Step 712). If the type of UI 3 is a mass storage protocol (MSP) interface, the message “Driver Initialization Completed (MSP Interface)” is displayed (Step 713). If the type of UI 3 is a picture transfer protocol (PTP) interface, a message “Driver Initialization Completed (PTP Interface)” is displayed (Step 714, please also refer to FIG. 8A).

Next, when it is determined that file transceiving is occurring (Step 715), a file transceiving state is displayed (Step 716). For example, when a file is moved according to a command by a user, the message “Move File” and state indication bars are displayed (please refer to FIG. 8B). When a file is copied according to a command by the user, the message “Copy File” and state indication bars are displayed (please refer to FIG. 8C). Steps 715 and 716 are repeated until an end signal is input (Step 717).

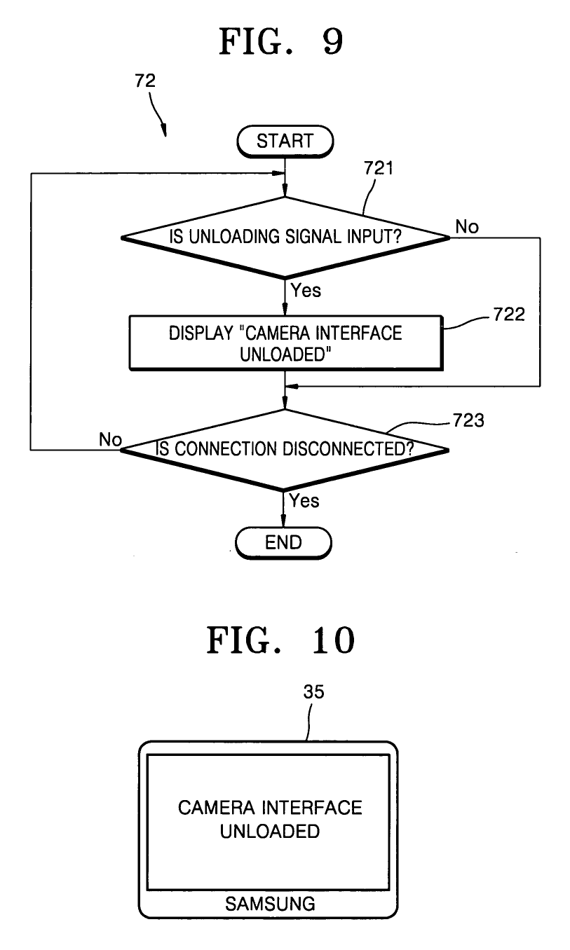

FIG. 9 shows an unloading display routine (Step 72) for the algorithm of FIG. 4. FIG. 10 shows a screen of the color LCD panel 35 when Step 722 of FIG. 9 is performed. The unloading display routine (Step 72) for the algorithm of FIG. 4 is described below with reference to FIGS. 4, 9 and 10.

When a user unloads the digital camera 1 from the PC by manipulating the PC, an unloaded signal is input to the DSP 507 from the control register 33, and the DSP 507 displays the message “Camera Interface Unloaded” (Steps 721 and 722; please also refer to FIG. 10). Steps 721 and 722 are repeated until the interface connection is physically disconnected by the user (Step 723).

While this invention has been particularly shown and described with reference to preferred embodiments thereof, it will be understood by those skilled in the art that various changes in form and details may be made therein without departing from the spirit and scope of the invention as defined by the appended claims. For example, the description above has been directed towards an embodiment incorporating the USB standard, but one of ordinary skill in the art can readily employ the present invention for use with other wired or wireless connections, including infrared connections and connections under any of the WiFi protocols. The communication interface is simply a portion of the camera that allows the camera to transmit data to an external device. In addition, the recording medium may take any number of forms, including solid state memory, and may be fixed or removable.

What is claimed is:

1. A digital camera comprising:
an optical system,
an optoelectric converter,
a recording medium,
a display, and
a digital signal processor including the capability of displaying a transceiving state of data files being transmitted to an external device or being received from an external device.

2. The digital camera of claim 1, wherein the digital camera further comprises:
a communication interface capable of transmitting data files to an external device and receiving data files from an external device.

3. The digital camera of claim 2, wherein the digital signal processor includes the capability of displaying an initialization state of the communication interface.

4. The digital camera of claim 1, wherein the digital signal processor includes the capability of displaying an electrical connection state between the digital camera and an external device.

5. The digital camera of claim 1, wherein the digital signal processor further includes the capability of monitoring the transceiving state of data files being transmitted to an external device or being received from an external device.

6. The digital camera of claim 1, wherein the external device is a computer.

7. The digital camera of claim 1, wherein the display is an LCD panel.

8. The digital camera of claim 1, wherein the recording medium is removable from the camera.

9. The digital camera of claim 1, wherein the recording medium comprises solid state memory.

10. A digital camera comprising:
an optical system,
an optoelectric converter,
a recording medium,
a display,
a communication interface capable of transmitting data files to an external device and receiving data files from an external device, and
a digital signal processor including the capability of displaying an initialization state of the communication interface.

11. The digital camera of claim 10, wherein the digital signal processor further includes the capability of displaying an electrical connection state between the digital camera and an external device.

12. The digital camera of claim 11, wherein the the digital signal processor further includes the capability of displaying a transceiving state of data files being transmitted to an external device or being received from an external device.

13. The digital camera of claim 10, wherein the communication interface is a USB interface.

14. A digital camera comprising:
a means for creating a digital photograph,
a means for storing digital image data,
a means for displaying data, and
a means for displaying a transceiving state of data files being transmitted to an external device or being received from an external device.

15. The digital camera of claim 14, further comprising:
a means for transmitting data files to an external device and receiving data files from an external device, and
a means for displaying an initialization state of the means for transmitting data files to an external device and receiving data files from an external device.

16. The digital camera of claim 14, further comprising:
a means for displaying an electrical connection state between the digital camera and an external device.

17. A method for monitoring the status of a digital camera, the method comprising:
displaying an initialization state while initializing a communication interface.

18. The method of claim 17, wherein the step of displaying an initialization state while initializing a communication interface comprises:
monitoring a connection between the digital camera and an external device,
waiting until the connection is complete before proceeding with initialization and display of the initialization state,
initializing the communication interface and displaying a message indicating the initializing of the communication interface,
determining whether the initialization is successful, and
if the initialization succeeds, displaying a message indicating the success of the initialization.

19. The method of claim 18, wherein the step of displaying an initialization state while initializing a communication interface further comprises:
if the initialization fails, displaying a message indicating the failure of the initialization.

20. The method of claim 18, wherein the step of displaying an initialization state while initializing a communication interface further comprises:
if the initialization fails, displaying a message offering guidance to remedy the failure.

21. The method of claim 17, further comprising:
displaying a transceiving state while transmitting or receiving a data file to or from an external device.

22. The method of claim 21, wherein the step of displaying a transceiving state while transmitting or receiving a data file to or from an external device further comprises:
determining whether a data file is being transmitted or received, and
displaying a message indicating status of transmission or reception of a data file.

23. The method of claim 22, wherein the step of displaying a transceiving state while transmitting or receiving a data file to or from an external device further comprises:
determining whether initialization of the communication interface is successful,
if initialization of the communication interface is successful, proceeding with the step of displaying a transceiving state while transmitting or receiving a data file to or from an external device, and
if initialization of the communication interface is not successful, terminating the step of displaying a transceiving state while transmitting or receiving a data file to or from an external device.

24. The method of claim 22, wherein the step of displaying a transceiving state while transmitting or receiving a data file to or from an external device further comprises:
determining the type of interface, and
displaying a message indicating the type of interface.

25. The method of claim 17, further comprising:
repeating the step of displaying a transceiving state while transmitting or receiving a data file to or from an external device until an end signal is input.

26. The method of claim 17, further comprising:
displaying an unloaded state after the digital camera is unloaded from an external device.

27. The method of claim 26, wherein the step of displaying an unloaded state after the digital camera is unloaded from an external device comprises:
determining whether an unloaded signal is input to the digital camera, and
if an unloaded signal is input, displaying a message indicating unloaded state of digital camera.

28. The method of claim 27, wherein the step of displaying an unloaded state after the digital camera is unloaded from an external device comprises:
determining if the digital camera is disconnected from the external device,
if the digital camera is not disconnected from the external device, repeating the step of displaying an unloaded state after the digital camera is unloaded from an external device.

29. A method for monitoring the status of a digital camera, the method comprising:
displaying a transceiving state while transmitting or receiving a data file to or from an external device.

30. The method of claim 29, wherein the step of displaying a transceiving state while transmitting or receiving a data file to or from an external device further comprises:
determining whether a data file is being transmitted or received, and
displaying a message indicating status of transmission or reception of a data file.

31. The method of claim 30, wherein the step of displaying a transceiving state while transmitting or receiving a data file to or from an external device further comprises:
determining whether initialization of a communication interface is successful,
if initialization of the communication interface is successful, proceeding with the step of displaying a transceiving state while transmitting or receiving a data file to or from an external device, and
if initialization of the communication interface is not successful, terminating the step of displaying a transceiving state while transmitting or receiving a data file to or from an external device.

32. The method of claim 30, wherein the step of displaying a transceiving state while transmitting or receiving a data file to or from an external device further comprises:
determining the type of interface, and
displaying a message indicating the type of interface.
